(19) United States
(12) Patent Application Publication
(10) Pub. No.: US 2009/0230938 A1
(43) Pub. Date: Sep. 17, 2009

(54) Electric Power Conversion Apparatus

(75) Inventor: Naoki Sakurai, Hitachi (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 12/336,096

(22) Filed: Dec. 16, 2008

(30) Foreign Application Priority Data
Mar. 12, 2008 (JP) 2008-061977

(51) Int. Cl. G05F 1/66

(52) U.S. Cl. 323/283

(57) ABSTRACT

In an electric power conversion apparatus, there is reduced deterioration in insulation of a means which is provided inside an IC chip and transmits a signal from a low electric potential system to a high electric potential system. The electric power conversion apparatus includes a lower-arm circuit 14 which transmits control signals from a micro computer 10 through the pulse transformers 22 and 23 provided inside an IC chip and outputs the control signal transmitted through the pulse transformer 23 to a lower-arm IGBT 1, a high-voltage nMOS 30 which converts the electric potential of the control signal for an upper-arm IGBT 3 transmitted through the pulse transformer 22 of the lower-arm circuit 14 and an upper-arm circuit 15 which outputs the control signal of which the electric potential is converted by the high-voltage nMOS 30 to the upper-arm IGBT 3.

### BACKGROUND OF THE INVENTION

1. Field of the Invention

The present invention relates to an electric power conversion apparatus.

2. Description of the Related Art

It is prevalent to control a motor by an electric power conversion apparatus using a switching element. In general, the emitter of an arm switching element configuring an electric power conversion is connected to the output of the electric power conversion apparatus, so that the arm switching element is driven in an electric-potentially floating state with respect to a main power-supply earth terminal. For example, when the arm switching element is turned on, a high voltage equal to a voltage of a main power supply is applied thereto. For this reason, a signal needs transmitting from a low electric potential system in a microcomputer to a high electric potential system powered by a main power supply in order to drive the arm switching element.

As a means for transmitting signals from a low electric potential system to a high electric potential system, there has been conventionally used an optocoupler. However, the optocoupler has problems in that its cost is high because a compound semiconductor is used as a light emitting element or a light emitting element is decreased in its light emitting intensity as time elapses to be inoperative.

A pulse transformer has been known as a means for transmitting signals from a low electric potential system to a high electric potential system without using the optocoupler. However, pulse transformer is larger in size and more expensive than the optocoupler. On the other hand, there has been known a technique in which a semiconductor process is applied to produce the pulse transformer on the silicon of an IC chip (for example, refer to Non-Patent Document 1). An upper and a lower arm driving signal inputted from a microcomputer are converted by a transmission circuit to signals which can be transmitted by the pulse transformer, passed through the pulse transformer, demodulated by a reception circuit, amplified by a buffer circuit and caused to turn on and off a switching element.

[Non-Patent Document 1] “Coreless transformer a new technology for half bridge driver IC's” PCIM Europe 2003, pp. 217 to 220

A strong electric field is applied to an insulator between windings of the pulse transformer produced in the IC chip because the pulse transformer is larger in displacement current per unit area and limited in thickness of its insulator. The long time use of the pulse transformer may deteriorate insulation. This point has not been considered enough in a conventional art.

### SUMMARY OF THE INVENTION

The object of the present invention is to reduce deterioration in insulation of a means which is provided inside an IC chip and transmits signals from a low electric potential system to a high electric potential system.

The present invention relates to an electric power conversion apparatus including a level shift circuit adapted to convert the electric potential of a control signal transmitted through a means for transmitting signals from a low electric potential system to a high electric potential system.

The present invention enables to reduce deterioration in insulation of a means which is provided inside an IC chip and transmits signals from a low electric potential system to a high electric potential system.

### BRIEF DESCRIPTION OF THE DRAWINGS

FIG. 1 is a circuit block diagram of an electric power conversion apparatus being one embodiment of the present invention;

FIG. 2 is a cross-section perspective view of a pulse transformer in FIG. 1;

FIG. 3 is an example of a transmission and a reception circuit for transmitting a signal from a micro computer using the pulse transformer in FIG. 2;

FIG. 4 is a circuit diagram of an electric power conversion apparatus being another embodiment of the present invention;

FIG. 5 is a circuit diagram of an electric power conversion apparatus being another embodiment of the present invention;

FIG. 6 is a circuit block diagram of an electric power conversion apparatus being another embodiment of the present invention;

FIG. 7 is a level shift circuit in FIG. 6;

FIG. 8 is a circuit block diagram illustrating how to divide the electric power conversion apparatus into chips in FIG. 6;

FIG. 9 is a schematic diagram illustrating an example of packaging in FIG. 6;

FIG. 10 is a circuit block diagram of an electric power conversion apparatus being another embodiment of the present invention;

FIG. 11 is a cross-section perspective view of a capacitor for the electric power conversion apparatus being another embodiment of the present invention; and

FIG. 12 is a block diagram using an embodiment illustrated in FIG. 11.

### DESCRIPTION OF THE PREFERRED EMBODIMENTS

The embodiment of the present invention is described below.

The present embodiment relates to a motor driving apparatus including at least one arm formed of a first and a second electric power switching element connected in series between a main terminal and, in particular, to an electric power conversion apparatus including a circuit adapted to transmit the control signal from a micro computer, especially from a low voltage circuit to a high voltage circuit.

Although an insulated gate bipolar transistor (IGBT) is exemplified below as a switch element, other semiconductor switching elements may be used.

In general, the ground of a high voltage power supply (or, ground on the side of a lower arm) to which the ground of a micro computer and the IGBT are connected is insulated by a transformer. However, a difference between voltages is substantially constant. On the other hand, the ground on the side of an upper arm is substantially equal to the high electric potential of the high voltage power supply when the upper arm IGBT is turned on or current flows back to the diode on the side of the upper arm, and the ground on the side of the upper arm is substantially equal to the ground electric potential of the lower arm when the lower arm IGBT is turned on or current flows back to the diode on the side of the lower arm. In other words, the IGBT is turned on and off to vary the ground electric potential of the upper arm. For this reason, the pulse transformer is also subjected to a temporal change (dV/dt) in a ground voltage between the upper and the lower ground. The product (dV/dt×C) of the temporal change dV/dt and a stray capacity C between the windings of a transformer flows as displacement current through the insulator between the windings of the transformer. A convention pulse transformer in which a winding is wound around a transformer manually or by a machine is wide in distance between the windings thereof and small in stray capacity, so that displacement current is small.

On the other hand, the pulse transformer produced in the IC chip can be approximately 10 μm in thickness of the insulator thereof owing to the limitation of the semiconductor process. For this reason, the pulse transformer produced in the IC chip is ten times or greater in displacement current per unit area than the convention pulse transformer in which a winding is wound around a transformer manually or by a machine. Furthermore, the thickness of the insulator is limited and an electric field allied to the insulator between the windings is greater than that allied to the convention pulse transformer. Therefore, the use of the pulse transformer for a long time may deteriorate insulation.

There are described below several embodiments to solve such problems.

### First Embodiment

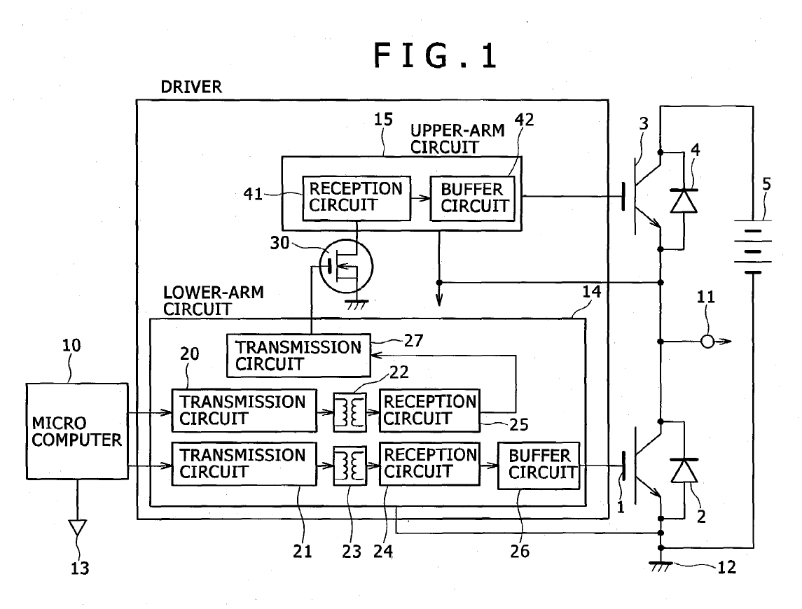

FIG. 1 is a circuit block diagram of an electric power conversion apparatus being one embodiment of the present invention.

A diode 2 is connected in parallel to a lower arm IGBT 1. A diode 4 is connected in parallel to an upper IGBT 3. The emitter of the upper arm IGBT 3 is connected to the collector of the lower arm IGBT 1. The center junction between the emitter and the collector as an output 11 is connected to the connection terminal of a motor (not shown). A micro-computer ground 13 of a micro computer 10 and a ground 12 of a high voltage power supply 5 are insulated. A lower-arm driving signal from the microcomputer 10 is modulated by a transmission circuit 21 of a lower-arm circuit 14 of a driver, passed through a pulse transformer 23, demodulated by a reception circuit 24, amplified by a buffer circuit 26 and caused to turn on and off the lower arm IGBT 1. An upper-arm driving signal from the microcomputer 10 is modulated by a transmission circuit 20, passed through a pulse transformer 22 and demodulated by a reception circuit 25. The demodulated upper-arm driving signal is modulated by a level shift circuit transmission circuit 27 and caused to drive a high-voltage nMOS for a level shift circuit 30. The drain of the high-voltage nMOS for the level shift circuit 30 is connected to a level shift circuit reception circuit 41 of an upper arm circuit 15 and caused to demodulate a signal in the level shift circuit transmission circuit 27. A signal in the level shift circuit reception circuit 41 is amplified by a buffer circuit 42 and caused to drive the upper arm IGBT 3.

In the present embodiment, the pulse transformer is used only for communication between the micro computer and the lower arm circuit 14. Although electric potential is different between the micro-computer ground 13 and the lower arm ground 12, the electric potential is not temporally changed, so that dV/dt is not caused. For this reason, even if the pulse transformer is used for a long time, the insulation thereof is not deteriorated. The signal is transmitted from the lower arm to the upper arm by a level shift circuit composed of the level shift circuit transmission circuit 27, the high-voltage nMOS for the level shift circuit 30 and the level shift circuit reception circuit 41. A high voltage is applied only to the high-voltage nMOS for the level shift circuit 30 by the level shift circuit. As long as a voltage lower than a withstand voltage is applied to the high-voltage nMOS, the high-voltage nMOS does not deteriorate insulation. As described above, the present embodiment enables the realization of the upper and the lower arm, IGBT driving circuit which do not deteriorate insulation even if the pulse transformer produced in the IC is used for a long time.

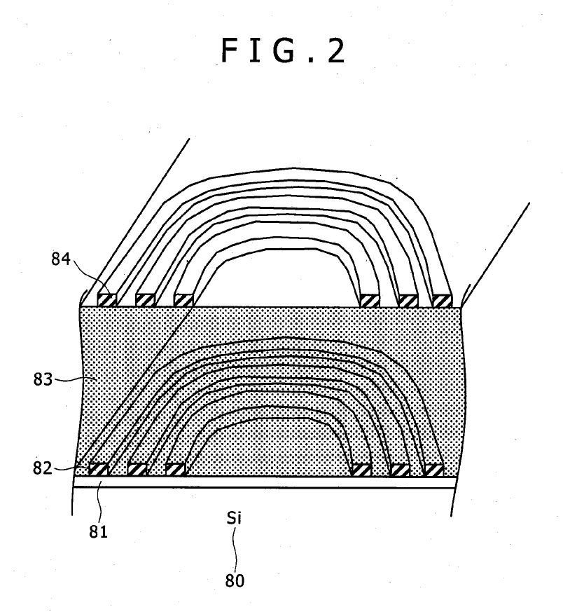

FIG. 2 is a cross-section perspective view of the pulse transformer produced in the IC. A wiring 82 is spirally formed on a thin oxide film 81 on silicon to form a primary coil (on the side of a micro computer). A wiring 84 is spirally formed through an insulator 83 to form a secondary coil (on the side of the lower arm).

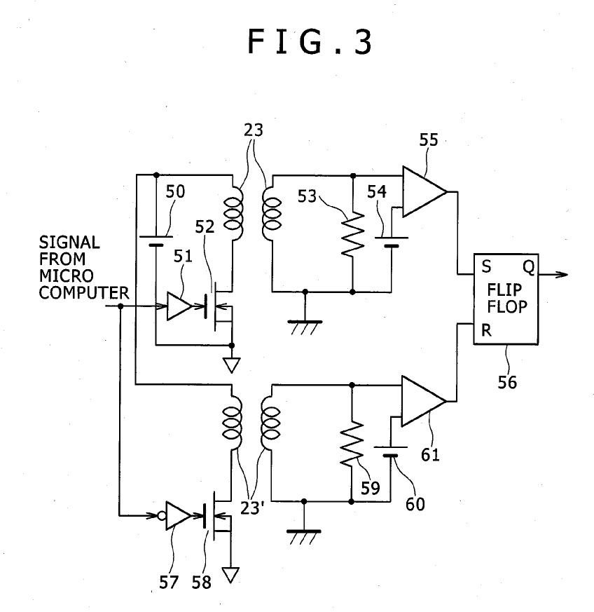

FIG. 3 is a first circuit of the transmission and the reception circuit in FIG. 1 for transmitting a signal from the micro computer using the pulse transformer in FIG. 2. The drain of the nMOSFET 52 is connected to the primary side of the pulse transformer 23 and the source thereof is connected to the micro-computer ground. One terminal of the primary side of the pulse transformer 23 is connected to high voltage side of a power supply 50. A micro-computer signal is inputted to the gate of the nMOSFET 52 through a buffer 51. A resistor 53 is connected to both ends of the secondary side of the pulse transformer 23. One terminal of the resistor is connected to a comparator 55. One terminal of the comparator 55 is connected to a reference electric potential 54. The output of the comparator 55 is inputted to the set side of a flip flop 56. The drain of the nMOSFET 58 is connected to the primary side of the pulse transformer 23′ and the source thereof is connected to the micro-computer ground. One terminal of the primary side of the pulse transformer 23′ is connected to high voltage side of the power supply 50. A micro-computer signal is inputted to the gate of the nMOSFET 58 through a NOT circuit 57. A resistor 59 is connected to the secondary side of the pulse transformer 23′. One terminal of the resistor is connected to a comparator 61. One terminal of the comparator 61 is connected to a reference electric potential 60. The output of the comparator 61 is inputted to the reset side of a flip flop 56.

The circuit operates as described below. When the micro-computer signal is turned to be a “H” level, the nMOSFET 52 is turned on to cause current to flow into the primary side of the pulse transformer 23, developing a voltage at the secondary side thereof. Since the pulse transformer formed in the IC cannot use a material high in magnetic permeability as a primary and a secondary core and the IC is small in area, the number of turns is limited to several tens to reduce inductance, lowering a voltage to be developed. Furthermore, since the wiring is thin, it is not possible to flow a large current, limiting a pulse width (time). For this reason, in the present embodiment, the edge of a driving signal from the micro computer is taken out to cause current to flow through the pulse transformer only for a short time. The voltage generated across the resistor on the secondary side is compared with the reference voltage by the comparator for the short time to take out the signal. One of two circuits is used for turning on (for setting), the other is used for turning off (for resetting). The flip flop performs demodulation.

Although the lower-arm pulse transformer 23 is described above, the description may be applicable to the upper-arm pulse transformer 22. The same holds true for the following other embodiments.

Thus, in a motor driving apparatus including at least one arm formed of a first and a second electric power switching element connected in series between a main terminal, the pulse transformer formed in the IC is used for transmitting a control signal from the micro computer to at least any of the arms and the level shift circuit including the high-voltage MOSMOS is used in a circuit for transmitting signals from the low voltage circuit to the high voltage circuit.

The two pulse transformers are used for transmitting control signals from the micro computer to the arms. The circuits are provided for turning on and off current on the primary side of the pulse transformers by a rising edge and a falling edge of the driving signal from the micro computer. A means for detecting a voltage is provided in the circuit for detecting the rising and the falling edge of the driving signal from the micro computer on the secondary side thereof. The flip flop is set by the detection circuit on the rising side and reset by the detection circuit on the falling side to provide a circuit for demodulating the driving signal from the micro computer.

Thus, since the ground electric potential is substantially constant between the micro computer and the ground, the pulse transformer is not subjected to dV/dt, preventing the insulation of the pulse transformer formed in the IC from being deteriorated when the pulse transformer is used for a long time.

### Second Embodiment

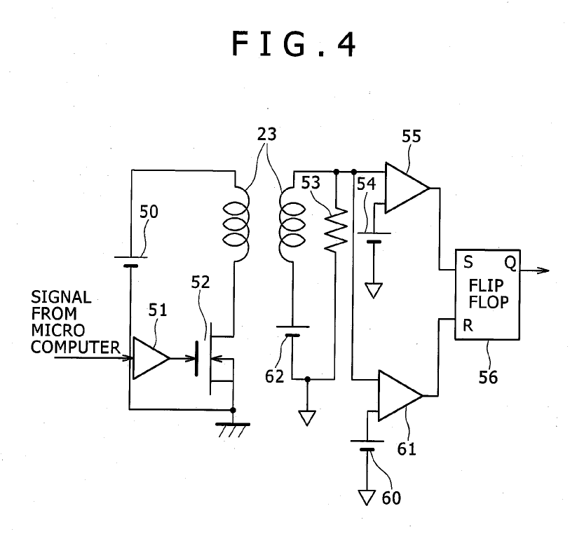

FIG. 4 is a circuit diagram of an electric power conversion apparatus being another embodiment of the present invention. The present embodiment is the same as the above embodiment except the following description.

The present embodiment provides a transmission and a reception circuit for transmitting a signal from the micro computer using the pulse transformer. Although the two pulse transformers are used in the first embodiment, one pulse transformer is used in the present embodiment. The drain of the nMOSFET 52 is connected to the primary side of the pulse transformer 23 and the source thereof is connected to the micro-computer ground. One terminal of the primary side of the pulse transformer 23 is connected to high voltage side of the power supply 50. A micro-computer signal is inputted to the gate of the nMOSFET 52 through the buffer 51. A reference power supply 62 is inserted between the secondary side of the pulse transformer 23 and the lower-arm ground. The resistor 53 is connected to both ends of the secondary side of the pulse transformer 23. One terminal of the resistor is connected to the comparator 55. One terminal of the comparator 55 is connected to the reference electric potential 54. The output of the comparator 55 is inputted to the set side of the flip flop 56. The high electric potential side of the resistor is also connected to the comparator. One terminal of the comparator 61 is connected to the reference electric potential 60. The output of the comparator 61 is inputted to the reset side of a flip flop 56. The nMOSFET 52 is turned on to generate a positive di/dt, developing a positive voltage at the secondary side. The nMOSFET 52 is turned off to generate a negative di/dt, developing a negative voltage at the secondary side. A difference in voltage is detected to demodulate turning on and off of the primary side on the secondary side. Since the comparator built in the IC does not operate by a negative electric potential, the reference power supply 62 serves to increase the electric potential to a voltage at which the comparator operates.

Thus, one pulse transformer is used for transmitting a control signal from the micro computer to the arm. The reference power supply is inserted between the secondary side of the pulse transformer and the ground. The two circuits are provided for detecting a voltage developed on the secondary side by turning on and off on the primary side. The flip flop is set by the detection circuit on the rising side and reset by the detection circuit on the falling side to provide a circuit for demodulating the driving signal from the micro computer.

### Third Embodiment

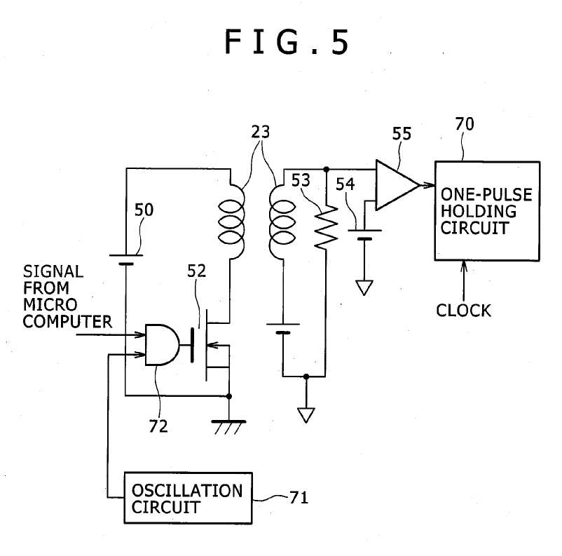

FIG. 5 is a circuit diagram of an electric power conversion apparatus being another embodiment of the present invention. The present embodiment is the same as the above embodiment except the following description.

The present embodiment provides a transmission and a reception circuit for transmitting a signal from the micro computer using the pulse transformer. The drain of the nMOSFET 52 is connected to the primary side of the pulse transformer 23 and the source thereof is connected to the micro-computer ground. One terminal of the primary side of the pulse transformer 23 is connected to high voltage side of the power supply 50. An AND of the micro-computer signal and the output of an oscillation circuit 71 is inputted to the gate of the nMOSFET 52. The resistor 53 is connected to both ends of the secondary side of the pulse transformer 23. One terminal of the resistor is connected to the comparator 55. One terminal of the comparator 55 is connected to the reference electric potential 54. The output of the comparator 55 is inputted to a one-pulse holding circuit 70.

The circuit operates as described below. A signal from the micro computer is ANDed with the output of the oscillation circuit 71 to divide a long ON signal into a short ON signal. The nMOSFET 52 is driven by the signal, so that a positive voltage is produced across the resistor each time the nMOSFET 52 is turned on. The voltage is detected and demodulated by the one-pulse holding circuit for each pulse.

Thus, only one pulse transformer is used for transmitting the control signal from the micro computer to the lower arm. The ON signal from the micro computer is temporally divided, current on the primary side of the pulse transformer is turned on and off by the divided signal to detect a voltage generated across the secondary side of the pulse transformer and the voltage is demodulated by the one-pulse holding circuit 70.

### Fourth Embodiment

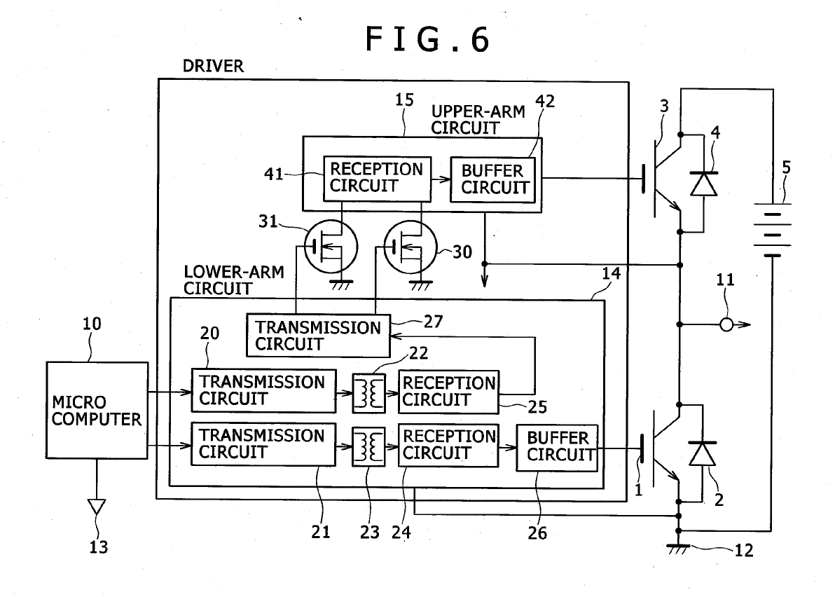

FIG. 6 is a circuit block diagram of an electric power conversion apparatus being another embodiment of the present invention. The present embodiment is the same as the above embodiment except the following description. The present embodiment uses two high-voltage nMOSs for the level shift circuit 30 and 31.

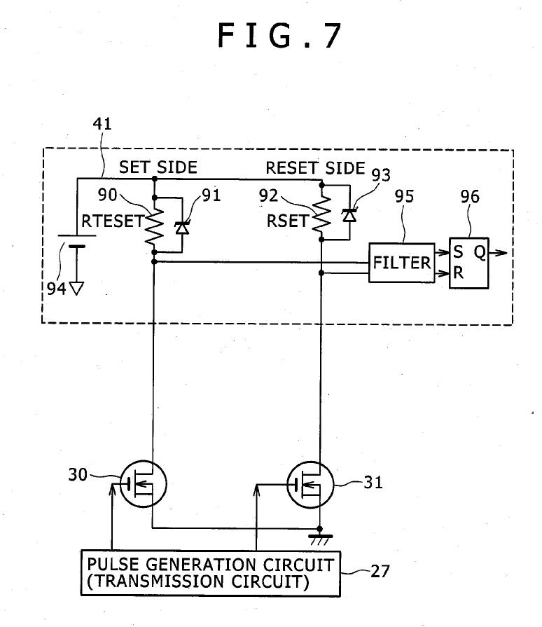

FIG. 7 is a level shift circuit in FIG. 6. A pulse generating circuit (transmission circuit) generates a signal for turning on the high-voltage nMOS 30 on the set side for a short time by a rising edge of the driving signal and a signal for turning on the high-voltage nMOS 31 on the reset side for a short time by a falling edge of the driving signal. A resistor 90 is connected to the drain of the high-voltage nMOS 30. The other side of the resistor 90 is connected to high voltage side of the upper-arm power supply 94. A Zener diode 91 is connected across the resistor 90. A resistor 92 is connected to the drain of the high-voltage nMOS 31. The other side of the resistor 92 is connected to high voltage side of the upper-arm power supply 94. A Zener diode 93 is connected across the resistor 92. A node between the drain of the high-voltage nMOS 30 and the resistor 90 is connected to the set side of a flip flop 96 through a filter 95. A node between the drain of the high-voltage nMOS 31 and the resistor 92 is connected to the reset side of the flip flop 96 through the filter 95. The reception circuit 41 in FIG. 6 is composed of the resistances 90 and 92, the Zener diodes 91 and 93, the filter 95 and the flip flop 96 enclosed by a dotted line in FIG. 7.

Thus, there is provided the level shift circuit for demodulating the upper-arm driving signal by the transmission circuit adapted to generate a pulse for turning on the high-voltage nMOS on the set side for a short time by a rising edge of the upper-arm driving signal and a pulse for turning on the high-voltage nMOS on the reset side for a short time by a falling edge of the upper-arm driving signal, two high-voltage nMOSs and the reception circuit composed of the resistor connected to the drain of the high-voltage nMOS on the set side, the circuit adapted to detect a voltage developed across the resistor, the resistor connected to the drain of the high-voltage nMOS on the reset side, the circuit adapted to detect a voltage developed across the resistor and the flip flop connected to a voltage detecting circuit.

Only one high-voltage nMOS for the level shift circuit is provided like the first embodiment, the high-voltage nMOS needs to be continued to be turned on so as to transmit the signal to the upper arm. In this case, current flows with a high voltage applied to the high-voltage nMOS, so that a loss is great. In the present embodiment, the high-voltage nMOS for the level shift circuit is turned on only for a short time, so that a loss is small.

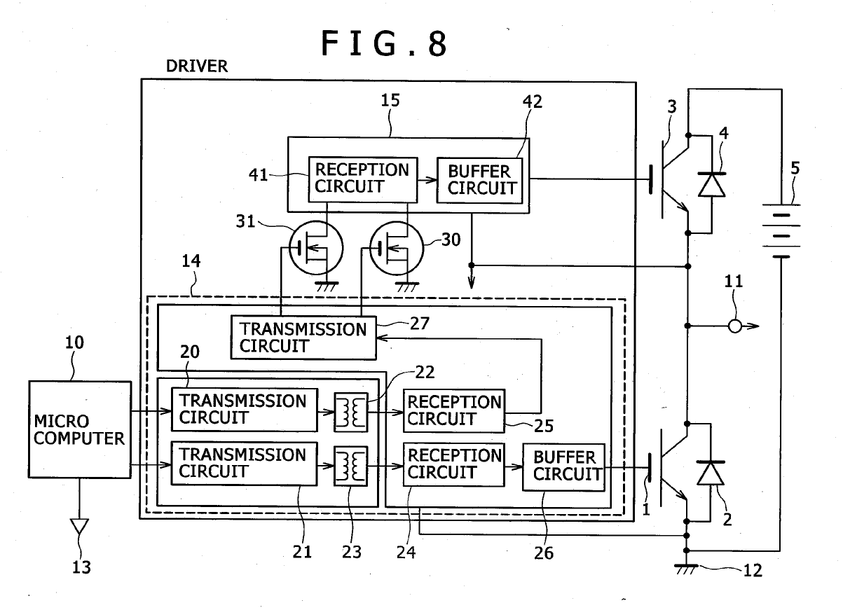

FIG. 8 is a circuit block diagram illustrating how to divide the electric power conversion apparatus into chips at the time of mounting the electric power conversion apparatus of the present embodiment on one package. The transmission circuits 20 and 21 and the pulse transformers 22 and 23 are integrated into one chip 200. The reception circuits 24 and 25, the buffer circuit 26 and the transmission circuit 27 of the level shift circuit are integrated into one chip 201. The reception circuit 41 of the level shift circuit and the buffer circuit 42 are integrated into one chip 202. The high-voltage nMOSs for the level shift circuit 30 and 31 are separate chips.

Thus, the pulse transformers and the transmission circuits thereof are integrated into one chip, the reception circuits of the pulse transformers and the transmission circuit of the level shift circuit are integrated into one chip, the high-voltage nMOSs are made of separate chips and the reception circuit of the level shift circuit is integrated into one chip. The pulse transformers and the transmission circuits and the reception circuits thereof may be integrated into one chip, and the level shift circuit including the high-voltage nMOSs may be integrated into one chip.

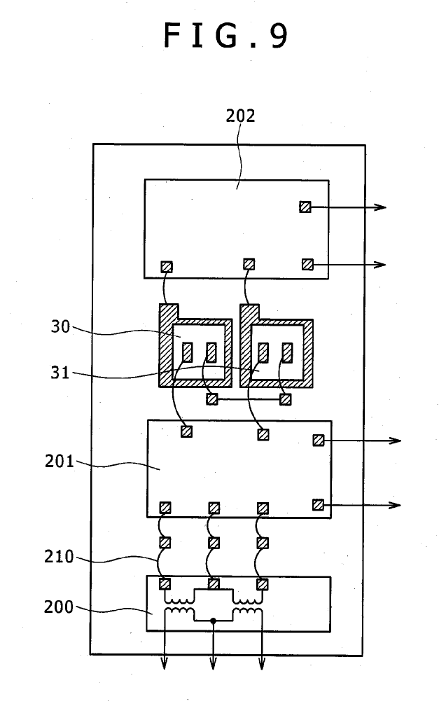

FIG. 9 is a schematic diagram illustrating the layout of a package of a chip for the case where the above components are mounted on one package. The chip 200 is arranged at the outermost side of the package. The chip 201 is arranged above the chip 200. The high-voltage nMOSs for the level shift circuit 30 and 31 are arranged between the chips 201 and 202. The chips are connected by wire bondings 210. Thus, dividing the chips on an electric potential basis enables reducing the influence of noise due to change in electric potential.

### Fifth Embodiment

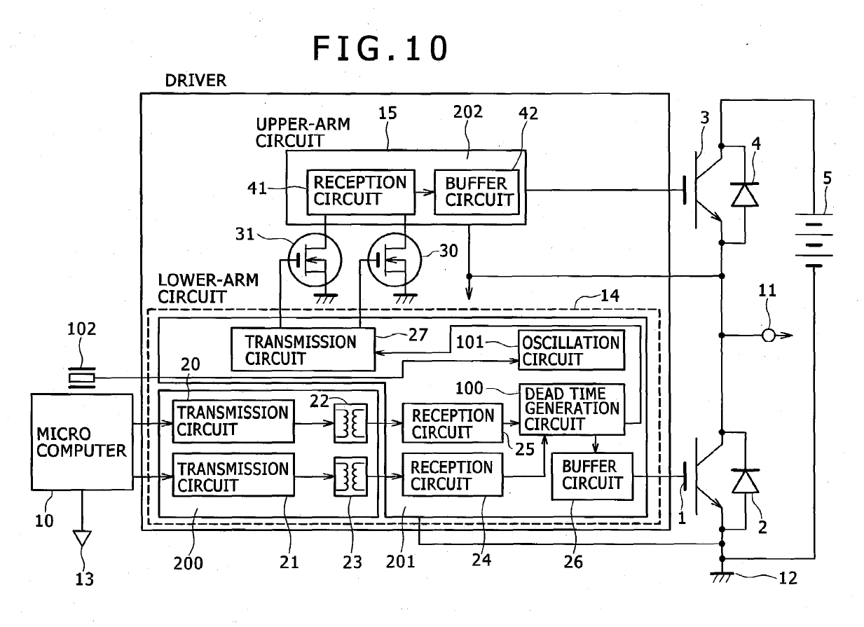

FIG. 10 is a circuit block diagram of an electric power conversion apparatus being another embodiment of the present invention. The present embodiment is the same as the above embodiment except the following description. The electric power conversion apparatus further incorporates an oscillation circuit 101 and a dead time generation circuit 100 in addition to the components in the electric power conversion apparatus illustrated in FIG. 6 and generates a dead time in the IC. FIG. 10 also illustrates how to divide the electric power conversion apparatus into chips at the time of mounting the electric power conversion apparatus of the present embodiment on one package. The transmission circuits 20 and 21 and the pulse transformers 22 and 23 are integrated into one chip 200. The reception circuits 24 and 25, the buffer circuit 26, the transmission circuit 101, the dead time generation circuit 100 and the transmission circuit 27 of the level shift circuit are integrated into one chip 201. The reception circuit 41 of the level shift circuit and the buffer circuit 42 are integrated into one chip 202. The high-voltage nMOSs for the level shift circuit 30 and 31 are separate chips.

Thus, the dead time generation circuit is integrated with the reception circuits for the pulse transformers and the transmission circuit 27 of the level shift circuit.

### Sixth Embodiment

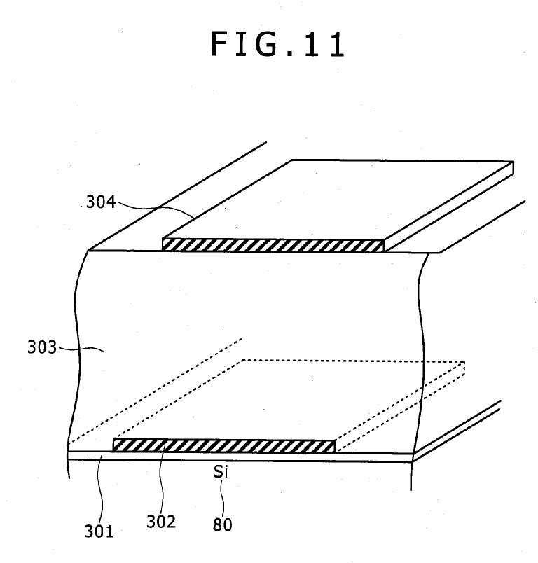

FIG. 11 is a cross-section perspective view of a capacitor for the electric power conversion apparatus being another embodiment of the present invention. The present embodiment is the same as the above embodiment except the following description.

In the above embodiments, although the pulse transformer formed on silicon has been used for transmitting a signal and insulating, a capacitance formed on silicon can also achieve the same function as the pulse transformer. In FIG. 11, a thin oxide film is formed on silicon 80 and an electrode 302 is formed on the thin oxide film. An electrode 304 insulated from the electrode 302 with an insulting film 303 is formed. In other words, a capacitance is formed of the electrodes 302 and 304 and the insulting film 303 as dielectrics.

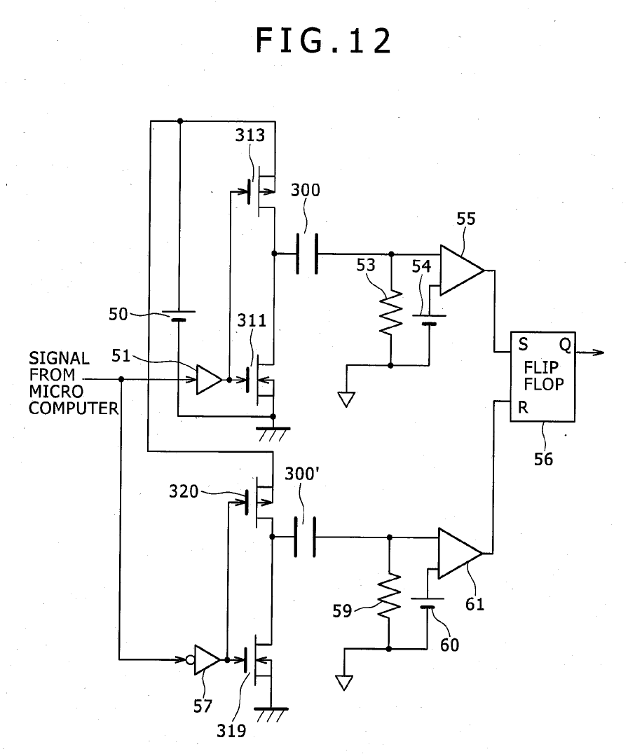

FIG. 12 is a block diagram using an embodiment illustrated in FIG. 11. The drains of the pMOSFET 313 and the nMOSFET 311 are connected to the capacitance 300. The source of the pMOSFET 313 is connected to high voltage side of the power supply 50. The source of the nMOSFET 311 is connected to the micro-computer ground. A signal from the micro computer is inputted to the gates of the pMOSFET 313 and the nMOSFET 311 through the buffer 51. The resistor 53 is connected to the other terminal of the capacitance 300 and connected to the comparator 55. The other terminal of the resistance 53 is connected to the lower-arm ground. The other terminal of the comparator 55 is connected to the reference power supply 54. The output of the comparator 55 is inputted to the set side of the flip flop 56. For the reset side, the drains of the pMOSFET 320 and the nMOSFET 310 are connected to the capacitance 300′. The source of the pMOSFET 320 is connected to high voltage side of the power supply 50. The source of the nMOSFET 319 is connected to the micro-computer ground. A signal from the micro computer is inputted to the gates of the pMOSFET 320 and the nMOSFET 319 through an inverter. The resistor 59 is connected to the other terminal of the capacitance 300′ and connected to the comparator 61. The other terminal of the resistance 59 is connected to the lower-arm ground. The other terminal of the comparator 61 is connected to the reference power supply 60. The output of the comparator 61 is inputted to the reset side of the flip flop 56.

In the present embodiment, when an ON signal is inputted from the micro computer, the pMOSFET 313 is turned on to momentarily generate a voltage across the resistor 53 through the capacitance 300. The comparator 55 detects change in the voltage to set the flip flop 56, outputting an ON signal. On the other hand, when an OFF signal is inputted from the micro computer, the pMOSFET 320 is turned on to momentarily generate a voltage across the resistor 59 through the capacitance 300′. The comparator 61 detects change in the voltage to reset the flip flop 56, outputting an OFF signal.

What is claimed is:

1. An electric power conversion apparatus comprising:
an upper- and a lower-arm switching element which are connected in series between terminals connected to a battery and the center junction of which is connected to the output terminal to a motor;
a micro computer which outputs a drive signal for driving the upper- and the lower-arm switching element;
a lower-arm circuit which is provided in a driver, transmits control signals from the micro computer for controlling the upper- and the lower-arm switching element through pulse transformers provided inside an IC chip and outputs the control signal for controlling the lower-arm switching element transmitted through the pulse transformer;
a level shift circuit which converts the electric potential of the control signal for controlling the upper-arm switching element transmitted through the pulse transformer of the lower-arm circuit; and
an upper-arm circuit which outputs the control signal for controlling the upper-arm switching element, the electric potential of which is converted by the level shift circuit, to the upper-arm switching element.

2. The electric power conversion apparatus according to claim 1, wherein
the lower-arm circuit comprises:
the two pulse transformers provided in transmission circuits for transmitting the control signals from the micro computer to either of the upper- or the lower-arm switching element;
an on-off circuit for turning on and off current on the primary side of the pulse transformer by a rising and a falling edge of the driving signal from the micro computer;
a voltage detecting circuit provided on the secondary side of the pulse transformer for detecting the rising and the falling edge of the driving signal from the micro computer; and
a demodulating circuit for demodulating the driving signal from the micro computer in such a manner that a flip flop is set by the voltage detecting circuit on the rising-edge side and the flip flop is reset by the detecting circuit on the falling-edge side.

3. The electric power conversion apparatus according to claim 1, wherein the lower-arm circuit comprises:
one pulse transformer of the pulse transformers provided in transmission circuits for transmitting the control signals from the micro computer to either of the upper- or the lower-arm switching element;
two detection circuits in which reference power supplies are inserted between the detection circuits and the grounds on the secondary sides of the pulse transformers and which detect voltages generated on the secondary sides of the pulse transformers by ON and OFF signals on the primary sides of the pulse transformers; and
a demodulating circuit for demodulating the driving signal from the micro computer in such a manner that a flip flop is set by the detecting circuit on the rising-edge side and the flip flop is reset by the detecting circuit on the falling-edge side.

4. The electric power conversion apparatus according to claim 1, wherein the lower-arm circuit comprises:
one pulse transformer of the pulse transformers provided in transmission circuits for transmitting the control signals from the micro computer to either of the upper- or the lower-arm switching element;
a circuit for temporally dividing an on-signal from the micro computer to cause the signal to turn on and off current on the primary side of the pulse transformer; and
one-pulse holding circuit for detecting and demodulating a voltage generated across the secondary side of the pulse transformer.

5. The electric power conversion apparatus according to claim 1, wherein the level shift circuit has two high-voltage nMOSFETs.

6. The electric power conversion apparatus according to claim 5, wherein the level shift circuit comprises:
a resistor connected to the drain of the high-voltage nMOSFET on the set side; and
a detection circuit adapted to detect a voltage developed across the resistor on the set side, for a signal from a transmission circuit generating a pulse for turning on the high-voltage nMOSFET on the set side for a short time by a rising edge of an upper-arm driving signal;
the level shift circuit further comprises:
a resistor connected to the drain of the high-voltage nMOSFET on the reset side; and
a detection circuit adapted to detect a voltage developed across the resistor on the reset side, for a signal from the transmission circuit generating a pulse for turning on the high-voltage nMOS on the reset side for a short time by a falling edge of the upper-arm driving signal; wherein
a flip flop circuit connected the detection circuit demodulates the driving signal for the upper arm.

7. The electric power conversion apparatus according to claim 1, wherein
the pulse transformers and the transmission circuits on the primary side of the pulse transformers are provided inside an one-chip IC and the reception circuits on the secondary side of the pulse transformers and the level shift circuit are provided inside the other one-chip IC.

8. The electric power conversion apparatus according to claim 7, wherein
the other one-chip IC includes a dead time circuit therein.

9. The electric power conversion apparatus according to claim 1, wherein
the pulse transformers, the transmission circuits on the primary side of the pulse transformers and the reception circuits on the secondary side of the pulse transformers are provided inside an one-chip IC and the level shift circuit is provided inside the other one-chip IC.

10. The electric power conversion apparatus according to claim 5, wherein
the pulse transformers and the transmission circuits on the primary side of the pulse transformers are provided inside an one-chip IC, the reception circuits on the secondary side of the pulse transformers and the level shift circuit are provided inside the other one-chip IC, the high-voltage MOSFETs are provided as a separate chip and a reception circuit in the level shift circuit is provided inside another IC chip.

11. The electric power conversion apparatus according to claim 1, wherein
when a signal different in voltage is transmitted between input and output, the pulse transformer is used for transmitting a signal while there is no temporal change in the voltage difference and the level shift circuit is used between input and output at which temporal change in the voltage is caused.

12. An electric power conversion apparatus comprising:
an upper- and a lower-arm switching element which are connected in series between terminals connected to a battery and the center junction of which is connected to the output terminal for a motor;
a micro computer which outputs a drive signal for driving the upper- and the lower-arm switching element;
a lower-arm circuit which is provided in a driver, transmits control signals from the micro computer for controlling the upper- and the lower-arm switching element through capacitors provided inside an IC chip and outputs the control signal for controlling the lower-arm switching element transmitted through the capacitors to the lower-arm switching element;
a level shift circuit which converts the electric potential of the control signal for controlling the upper-arm switching element transmitted through the capacitor of the lower-arm circuit; and
an upper-arm circuit which outputs the control signal for controlling the upper-arm switching element, the electric potential of which is converted by the level shift circuit, to the upper-arm switching element.

13. The electric power conversion apparatus according to claim 12, wherein the lower-arm circuit comprises:
the two pulse transformers provided in transmission circuits for transmitting the control signals from the micro computer to either of the upper- or the lower-arm switching element;
an on-off circuit for turning on and off current on the primary side of the pulse transformer by a rising and a falling edge of the driving signal from the micro computer;
a voltage detecting circuit provided on the secondary side of the pulse transformer, for detecting the rising and the falling edge of the driving signal from the micro computer; and
a demodulating circuit for demodulating the driving signal from the micro computer in such a manner that a flip flop is set by the detecting circuit on the rising-edge side and the flip flop is reset by the detecting circuit on the falling-edge side.
